(19) United States
(12) Patent Application Publication
(10) Pub. No.: US 2024/0323192 A1
(43) Pub. Date: Sep. 26, 2024

(54) METHOD, APPARATUS, AND COMPUTER-READABLE RECORDING MEDIUM FOR CONTROLLING EXECUTION OF EVENT STREAM-BASED CONTAINER WORKLOAD IN CLOUD ENVIRONMENT

(71) Applicant: SGA Solutions Co.,Ltd., Seoul (KR)

(72) Inventors: Ki Uk LEE, Seongnam-si (KR); Ju Young PARK, Seongnam-si (KR); Bum Su KIM, Seoul (KR)

(21) Appl. No.: 18/019,533

(22) PCT Filed: Dec. 21, 2021
(86) PCT No.: PCT/KR2021/019477

§ 371 Date: Feb. 3, 2023

(30) Foreign Application Priority Data
Dec. 13, 2021 (KR) 10-2021-0177529

(51) Int. Cl. H04L 9/40

(52) U.S. Cl. CPC H04L 63/101; H04L 63/0823; H04L 63/20

(57) ABSTRACT

A method for controlling execution of an event stream-based container workload in a cloud environment includes: an authentication step of extracting identification information of the user account and confirming whether the extracted identification information is registered in a user policy module by hooking AdmissionView data using a webhook server; an authorization step of determining execution authority of the AdmissionView data requested by the user account based on a security role and a security level set in the authenticated user account, and verifying AdmissionView data based on best practices, when it is determined from the user policy module that the user account is an authenticated user account as a result of the authentication step; and an access control step of controlling access to the AdmissionView data requested to the Kubernetes API server by the user account according to a result of the authorization step.

### BACKGROUND OF THE INVENTION

### 1. Field of the Invention

The present invention relates to a method for controlling execution of an event stream-based container workload in a cloud environment, and more specifically, to a technology to control malicious behavior on a container workload with a policy-based admission control mechanism by utilizing rule-based access control (RBAC) based on a security group, a security role, and a security level in a security kernel through expansion of admission controller plugin, which is a controller that controls dynamic authorization of Kubernetes.

### 2. Description of the Related Art

Kubernetes is a management system for quickly creating clouded applications and providing orchestration and scale-in/up of containers automatically distributed, and is being variously used in a recent cloud environment.

In particular, such Kubernetes can operate in on-premise environment in which software is installed and used directly on a server and external hybrid cloud environment, and can update and manage the software in an open-source software method by developers in general development environment with global companies, such as Google, Microsoft, and Amazon, by supporting operation of large-scale cloud services while optimizing the software in a microservices architecture method. In recent years, various systems using such Kubernetes are being developed.

For example, Korean Registered Patent No. 10-2192442 proposes a technology, in which the technology is for improving processing performances through leader distribution in a Kubernetes platform environment, and for selecting and distributing leaders of newly distributed applications in consideration of a leader distribution status of the application distributed in a Kubernetes cluster.

However, in the above-mentioned Kubernetes, since access to/execution of all clusters on a container workload is approved/stored through an API server, which is a master component, but authentication and access control functions of individual user accounts are not inserted by default, all service accounts are bonded to each other in versions prior to 1.8, easily leading to full access to the cluster or stealing of security information. In fact, there is a big security issue, such as a case of Tesla being hacked through access to a Kubernetes dashboard.

Meanwhile, in order to solve the security issue, Kubernetes provides basic security policies such as cluster security policy, node security policy, and pod security policy, but these security policies have limitations in controlling malicious behaviors described above, such that countermeasures for the malicious behaviors are urgently required.

### SUMMARY OF THE INVENTION

Accordingly, the present invention is to control malicious behavior on a container workload with a policy-based admission control mechanism by utilizing RBAC based on a security group, a security role, and a security level in a security kernel through expansion of admission controller plugin, which is a controller that controls dynamic authorization to access/execute all clusters on Kubernetes.

To achieve the object described above, there is provided a method for controlling execution of an event stream-based container workload in a cloud environment, which is implemented by a computing device including one or more processors and one or more memories for storing instructions executable in the processors, the method including: an authentication step of performing authentication on a user account by extracting identification information of the user account and confirming whether the extracted identification information is registered in a user policy module by hooking AdmissionView data, which is requested to a Kubernetes application programming interface (API) server through an interface including at least one of a command line interface (CLI) and an API, using a webhook server; an authorization step of determining execution authority of the AdmissionView data requested by the user account based on a security role and a security level set in the authenticated user account, and verifying AdmissionView data based on best practices, when it is determined from the user policy module that the user account is an authenticated user account as a result of the authentication step; and an access control step of controlling access to the AdmissionView data requested to the Kubernetes API server by the user account according to a result of the authorization step.

The authentication step may preferably include extracting information including at least one of header information about a request for the AdmissionView data, host information for requesting the AdmissionView data, and verbs request information about resources specified in the AdmissionView data as the identification information extracted from the AdmissionView data.

In addition, the authorization step may preferably include confirming whether the execution authority of the requested AdmissionView data is given to the user account by using role-based access control (RBAC), attribute-based access control (ABAC), and webhook.

In addition, the authorization step may preferably include: a first determination step of determining whether an IP address and a service port number of the user account are pre-registered host information by confirming whether the IP address and the service port number of the user account are registered in the user policy module; a second determination step of determining whether the IP address of the user account is an IP address accessible to the Kubernetes API server after the first determination step; and a third determination step of determining whether the user account has authority to execute verbs for resources specified in AdmissionView when the user account satisfies preset determination criteria as results of the first determination step and the second determination step.

In addition, the first determination step may preferably include grasping the security role and the security level set in the user account by comparing the IP address and the service port number of the user account with access authority set for each namespace.

In addition, the authentication step may preferably include determining whether the user account is a valid user account by using a unit including at least one of a client certificate of the user account, a bearer token, an authentication proxy, and http basic authentication.

In addition, the access control step may preferably include permitting execution of the requested AdmissionView data by allowing the user account to access the Kubernetes API server when the execution authority of the AdmissionView data is given to the user account, and denying the access of the user account to the Kubernetes API server when the execution authority of the AdmissionView data is not given to the user account.

Meanwhile, there is provided an apparatus for controlling execution of an event stream-based container workload in a cloud environment, which is implemented by a computing device including one or more processors and one or more memories for storing instructions executable in the processors, the apparatus including: an authentication unit that performs authentication on a user account by extracting identification information of the user account and confirming whether the extracted identification information is registered in a user policy module by hooking AdmissionView data, which is requested to a Kubernetes API server by the user account, using a webhook server; an authorization unit that determines execution authority of the AdmissionView requested by the user account based on a security role and a security level set in the authenticated user account, and verifying verifies AdmissionView data based on best practices, when it is determined from the user policy module that the user account is an authenticated user account as a result of a function of the authentication unit; and an access control unit that controls access to the AdmissionView data requested to the Kubernetes API server by the user account according to a result of a function of the authorization unit.

On the other hand, a computer-readable recording medium that stores instructions for allowing a computing device to perform the following steps, wherein the steps include: an authentication step of performing authentication on a user account by extracting identification information of the user account and confirming whether the extracted identification information is registered in a user policy module by hooking AdmissionView data, which is requested to a Kubernetes API server from the user account, using a webhook server; an authorization step of determining execution authority of the AdmissionView data requested by the user account based on a security role and a security level set in the authenticated user account, and verifying AdmissionView data based on best practices, when it is determined from the user policy module that the user account is an authenticated user account as a result of the authentication step; and an access control step of controlling access to the AdmissionView data requested to the Kubernetes API server by the user account according to a result of the authorization step.

According to one embodiment of the present invention, it is possible to control malicious behavior on a container workload with a policy-based admission control mechanism by utilizing RBAC based on a security group, a security role, and a security level in a security kernel through expansion of admission controller plugin, which is a controller that controls dynamic authorization of Kubernetes.

In addition, according to one embodiment of the present invention, absence of authority setting according to a role of the user, which occurs since all service accounts accessible to the cluster are bound to each other, can be solved in association with a security kernel, so that it is possible to block malicious execution on a container workload that occurs at a security kernel level for PAM and unauthorized users.

In addition, according to one embodiment of the present invention, when root authority in a cloud management system is stolen, it is possible to block malicious execution on a container workload such as malicious behavior of distribution/execution/modification/deletion of containers or container images through access control of a security kernel user and container breakout that represents access to sensitive information on a host, for example, avoiding isolation monitoring of containers or obtaining additional authority.

That is, the present invention can enhance security of a Kubernetes dashboard having no access control function by blocking access of an unauthenticated host to the Kubernetes API server.

### BRIEF DESCRIPTION OF THE DRAWINGS

FIG. 1 is a flowchart of a method for controlling execution of an event stream-based container workload in a cloud environment according to one embodiment of the present invention.

FIG. 2 is an architecture of the method for controlling execution of an event stream-based container workload in a cloud environment according to one embodiment of the present invention.

FIG. 3 is a flowchart of execution authority determination for access to AdmissionView data according to one embodiment of the present invention.

FIGS. 4 and 5 are diagrams showing examples of webhook logs according to one embodiment of the present invention.

FIG. 6 is a configuration diagram of an apparatus for controlling execution of an event stream-based container workload in a cloud environment according to one embodiment of the present invention.

FIG. 7 is a diagram showing an example of an internal configuration of a computing device according to one embodiment of the present invention.

### DETAILED DESCRIPTION OF THE INVENTION

Hereinafter, various embodiments and/or aspects will be disclosed with reference to drawings. In the following description, multiple concrete details will be disclosed in order to help general understanding of one or more aspects for the purpose of description. However, it will be recognized by those skilled in the art that the aspect(s) can be executed without the concrete details. In the following disclosure and accompanying drawings, specific exemplary aspects of one or more aspects will be described in detail. However, the aspects are exemplary, and some equivalents of various aspects may be used, and the descriptions herein are intended to include both the aspects and equivalents thereto.

It is not intended that any “embodiment”, “example”, “aspect”, “illustration”, and the like used in the specification is preferable or advantageous over any other “embodiment”, “example”, “aspect”, “illustration”, and the like.

Further, the terms “includes” and/or “including” mean that a corresponding feature/or component exists, but it should be appreciated that the terms “include” or “including” mean that presence or addition of one or more other features, components, and/or a group thereof is not excluded.

Further, terms including an ordinal number such as “first” or “second’ may be used for the names of various components, not limiting the components. These expressions are used to distinguish one component from another component. For example, a first component may be referred to as a second component and vice versa without departing the scope of the present disclosure. The term “and/or” includes a combination of a plurality of related enumerated items or any of the plurality of related enumerated items.

In addition, unless otherwise defined, all terms used herein, including technical or scientific terms, have the same meaning as commonly understood by one of ordinary skill in the art to which this invention belongs. Terms such as those defined in commonly used dictionaries should be interpreted as having a meaning consistent with the contextual meaning of the related art and should not be interpreted as either ideal or overly formal in meaning unless explicitly defined in the present disclosure.

The present invention relates to a method for controlling execution of an event stream-based container workload in a cloud environment. Specifically, an object of the present invention is to provide a technology to control malicious behavior on a container workload with a policy-based admission control mechanism by utilizing RBAC based on a security group, a security role, and a security level in a security kernel through expansion of admission controller plugin, which is a controller that controls dynamic authorization of Kubernetes.

Meanwhile, a detailed description of the present invention for achieving the above object will be hereinafter described with reference to accompanying drawings, and a plurality of drawings will be referenced simultaneously to describe one or more technical features or components constituting the invention.

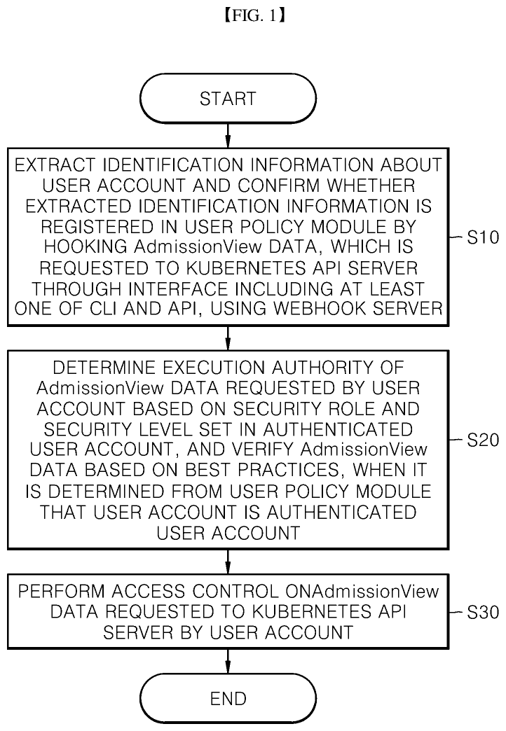

FIG. 1 shows a flowchart of a method for controlling execution of an event stream-based container workload in a cloud environment according to one embodiment of the present invention.

As shown in FIG. 1, in the present invention, first, an authentication step S10 of performing authentication on a user account by extracting identification information of the user account and confirming whether the extracted identification information is registered in a user policy module by hooking AdmissionView data, which is requested to a Kubernetes API server through an interface including at least one of a CLI and an API, using a webhook server, may be performed.

In this case, the CLI is the abbreviation for command line interface, which may be understood as a concept of a method in which the user interacts with a computer through a text terminal, and the API is the abbreviation for application programming interface, which may be understood as providing a Kubernetes function through a RESTful interface.

In addition, the “hooking” in S10 may be defined as an act of a webhook server intercepting the AdmissionView data requested to the Kubernetes API server by the user account, and the identification information extracted from the AdmissionView data in S10 may be understood as information including at least one of header information about a request for the AdmissionView data, host information for requesting the AdmissionView data, and verbs request information about resources specified in the AdmissionView data.

In this case, the “AdmissionView” may be understood as a concept of an object which includes manifest data requested to the Kubernetes API server by the user, and the verbs request information about resources specified in the AdmissionView data may be understood as extracting information about a request to generate POD named “curl” from the AdmissionView data.

Meanwhile, the POD may be understood as the smallest computing unit that may be generated/managed and distributed in Kubernetes, and the POD shares one or more container groups and has a specification for a method of running the corresponding containers.

As described above, in S10 of FIG. 1, authentication is performed on the user account by confirming whether the extracted identification information is registered in the user policy module.

Specifically, in S10, it is determined whether the user account is a valid user account by using a unit including at least one of a client certificate of the user account, a bearer token, an authentication proxy, and http basic authentication.

Specifically, the authentication based on the client authentication may be performed, for example, by means of X.509 certificate, in which the X.509 certificate is automatically generated when Kubernetes is installed and when kubect1 is executed directly on a master node server, a kubeconfig file referenced by kubect1 includes certificate contents.

This certificate is one of sub-certificates generated using ca.crt in/etc/kubernetes/pki directory of a master node as a root certificate, in which when the sub-certificate is generated, a user and a group are designated, and in this case, a value of system:masters designated as a group name is connected to a cluster role “cluster-admin” existing in actual Kubernetes and has an administer authority.

That is, the authentication based on the client certificate may be understood as determining whether the user account is a valid user account by first confirming whether information, which corresponds to the identification information extracted from the user account, exists in the kubeconfig file as the cluster information, when an external user account accesses the Kubernetes API server.

On the other hand, as another embodiment, the authentication based on the bearer token may be understood as a method for confirming whether the user account is a valid client by transmitting the identification information of the user account extracted to the webhook server.

That is, when the user account sends an authentication request to the Kubernetes API server including authentication data in a header after issuing the authentication data in advance, the Kubernetes API server transmits the authentication data to the webhook server and performs a validity test for the authentication data received based on client information pre-registered in the user policy module, thereby determining whether the user account is a valid user account.

In this case, the authentication based on the bearer token also has an advantage in that ASP. NET Core ID middleware is not required because user all information storages and authentications are processed by an ID service.

In addition, as another embodiment, the authentication of the user account herein may be performed based on a proxy.

As one embodiment, in the present invention, a proxy is set in curl using a command of kubctl proxy and an API URL is called using the proxy to retrieve access authority of the user account, which is currently stored in the kubeconfig file, so that the access authority of the user account is confirmed, and accordingly, it is determined whether the user account corresponds to a valid user account for access to the AdmissionView data requested by the user.

Meanwhile, when a proxy server is used for authentication of the user account, it is preferable in the present invention that before the authentication request for the user account is provided to the Kubernetes API server, the authentication request for the user account is transmitted to the proxy server to preemptively perform authentication on the user account, thereby enhancing security for access to the Kubernetes API server.

On the other hand, as another embodiment, the http basic authentication may be used as an authentication method of the user account in the present invention.

Specifically, the http basic authentication is one of authentication methods provided in the http protocol, and may be understood as a method for performing authentication on the user account by requesting an input of a user name and password to the user account for confirming the user account by the Kubernetes API server.

The http basic authentication is simple and convenient, but is not suitable for single use because there is a risk of exposing the user name and password, so that it is preferable to use the authentication in combination with an encryption technology such as SSL.

Furthermore, the authentication method of the user account in S10 may selectively use any one of the above-described embodiments, but preferably use two or more authentication units to determine whether the user account, which requests the AdmissionView data, is valid or illegal, so that it is preferable to improve reliability the authentication of the user account.

Meanwhile, after the S10, when it is determined from the user policy module that the user account is an authenticated user account as a result of S10, an authorization step S20 of determining execution authority of the AdmissionView data requested by the user account based on a security role and a security level set in the authenticated user account, and verifying AdmissionView data based on best practices, may be performed.

Preferably, in S20, it may be confirmed whether the execution authority of the requested AdmissionView data is given to the user account by using role-based access control (RBAC), attribute-based access control (ABAC), and webhook.

In this case, the RBAC manages authority of a Kubernetes system based on a role and gives specific authority to the user in combination with two roles, in which the role is a set of rules in which specific APIs, resources (POD, Deploy, etc.), and a use authority are specified in a manifest file, and functions to manage authority for a specific namespace.

That is, accordingly, the RBAC may be understood as a concept of a method for controlling access to resources based on roles of individual users in a cluster.

In addition, the ABAC may be understood as performing management on authority of the user account based on attributes. The ABAC may use all types of attributes such as a user attribute, a resource attribute, an object attribute, and an environment attribute, and as embodiment, one an attribute of user/group/security may be used in the present invention.

In addition, as another embodiment, access authority for resources of the user account may be controlled using webhook in the present invention.

In this case, the webhook may be understood as a concept of http callback, and manages authority set in the user account by querying an external REST service when the Kubernetes API server confirms the user authority.

That is, in S20 of the present invention, the webhook may be understood as performing a function to allow the user account to determine whether the execution authority of the AdmissionView data requested by the user account exists by using the unit including at least one of the RBAC, the ABAC, or the webhook, after the webhook server is associated with the security kernel.

More specifically, in the present invention, a first determination step of determining whether an IP address and a service port number of the user account are pre-registered host information by confirming whether the IP address and the service port number of the user account are registered in the user policy module, is performed.

In this case, the first determination step is performed to identify whether the user account is a valid user account, and when it is determined that the IP address and the service port number of the user account, which requests the AdmissionView data, are not registered in the user policy module, the user account may be determined as an illegal user account.

In addition, when the IP address and the service port number of the user account, which requests the AdmissionView data, are registered in the user policy module, the user account may be determined as a valid user account, and a process for comparing the IP address and service port number identified as the valid user account with access authority set for each namespace is performed.

In this case, the namespace mentioned above is a logical concept of a cluster, which may be understood as a concept of existence of plural namespaces in one cluster, and comparison of the access authority for the namespace (user/group/security/cluster) may be understood as identification of levels of the access authority set in the user account.

Next, after the first determination step, a second determination step of determining whether the IP address of the user account is accessible to the Kubernetes API server, is performed.

In addition, as results of the first determination step and the second determination step, a third determination step of determining whether the user account has authority to execute verbs for resources specified in AdmissionView is performed, when the user account satisfies preset determination criteria (that is, when all determination results of the first determination step and the second determination step are permitted access to the Kubernetes API server).

In this case, the resources refer to Kubernetes objects to be executed, such as PODs, service nodes, crontabs, and endpoint, and verbs for such resources may refer to a concept of specifying an action to be performed, such as create, update, delete, patch, list, watch, and get.

Meanwhile, in the third determination step, a process for comparing an access control policy registered in an access control list (ACL) of the associated security kernel with the access authority set in the user account.

In this case, the ACL module may be understood as a concept of a system that supports infrastructures for various types of access control lists in an operating system. In the present invention, since subjects to execute verbs for resources specified in the AdmissionView are designated in the ACL, the ACL module may control execution of the verbs by confirming whether the user account has authority to execute the verbs for resources specified in the AdmissionView.

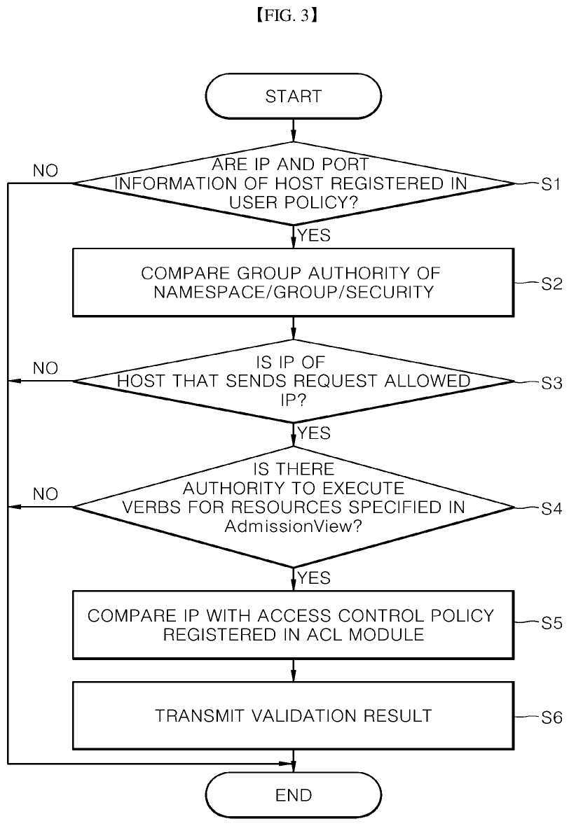

Meanwhile, a detailed process for S20 can be seen in S1 to S5 of FIG. 3.

In addition, after S5 is performed as shown in FIG. 3, in the present invention, S6 may be further performed to provide the webhook server with a validity determination result for the execution authority of information about an AdmissionView data request according to results of S1 to S5, and the present invention is not limited thereto.

Referring back to FIG. 1, after S20, an access control step S30 of performing access control for the AdmissionView data requested to the Kubernetes API server by the user may be performed according to the result of S20.

Specifically, S30 may be understood as that execution of the requested AdmissionView data is permitted by allowing the user account to access the Kubernetes API server when the execution authority of the AdmissionView data is given to the user account. In contrast, S30 may be understood as that the access of the user account to the Kubernetes API server is denied when the execution authority of the AdmissionView data is not given to the user account.

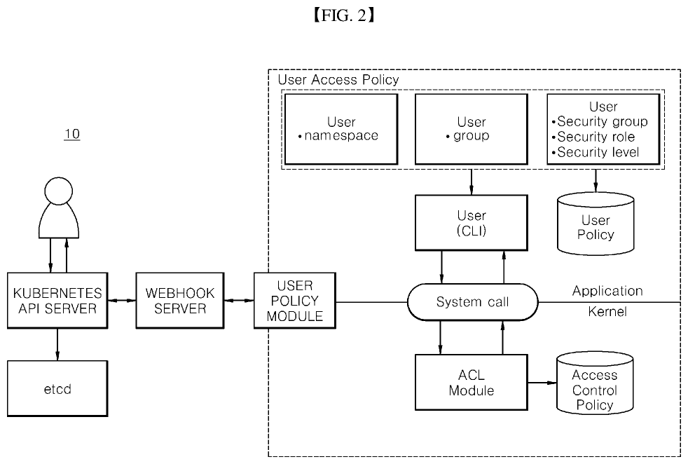

Meanwhile, in 10 of FIG. 2, it is possible to confirm an architecture representing an associative relationship between components of the method for controlling execution of an event stream-based container workload in a cloud environment of the present invention.

As shown in FIG. 2, etcd used for a basic data storage of the Kubernetes API server is provided in the present invention, and in this case, and etcd may be understood as a concept of a database that stores all data required to the Kubernetes API server in the form of key-value.

As described above, it can be seen in FIG. 2 that the Kubernetes API server is connected to the webhook and the webhook server is connected to the user policy module.

According to such an architecture, when it is determined that the user account requests the AdmissionView data to the Kubernetes API server, the webhook server extracts the header information about the AdmissionView data and the verbs request information for resources specified in the AdmissionView data from the AdmissionView data in order to identify the user account in the AdmissionView data requested by the user account.

Thereafter, in the present invention, it may be determined whether the user account is a valid user account pre-registered in the user policy module, and an access authority level of the user account may be grasped to derive a result thereof from the extracted information, so that it is possible to determine access control for allowance or denial for the access to the AdmissionView data requested to the Kubernetes API server by the user account.

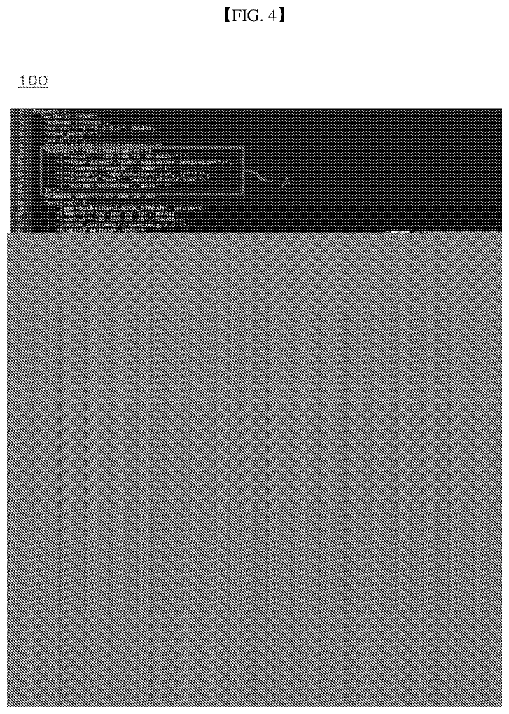

More specifically, referring to FIG. 4, embodiment 100 of FIG. 4 is attached with a webhook log in the method for controlling execution of an event stream-based container workload in a cloud environment, which has been described above, and may be understood as that a part marked with A is an example of extracting the header information about the AdmissionView data, a part marked with B is an example of extracting information about a host sending the AdmissionView data, and a part marked with C is an example of extracting information about a request to generate POD named “curl”.

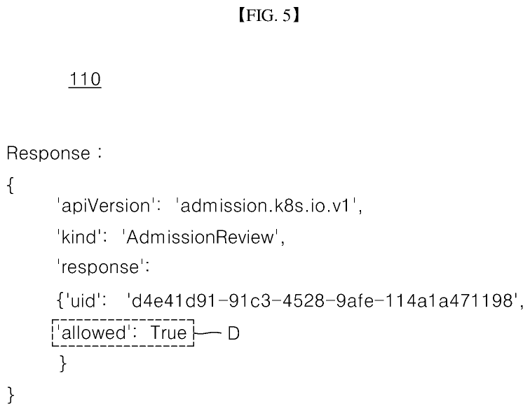

Furthermore, embodiment 110 of FIG. 5 may show an example of a result value for allowing the access to the AdmissionView data requested to the Kubernetes API server by the user account, as a determination result of embodiment 100 of FIG. 4.

That is, comprehensively, according to one embodiment of the present invention, it is possible to control malicious behavior on a container workload with a policy-based admission control mechanism by utilizing RBAC based on a security group, a security role, and a security level in a security kernel through expansion of admission controller plugin, which is a controller that controls dynamic authorization of Kubernetes.

In addition, according to one embodiment of the present invention, absence of authority setting according to a role of the user, which occurs since all service accounts accessible to the cluster are bound to each other, can be solved in association with a security kernel, so that it is possible to block malicious execution on a container workload that occurs at a security kernel level for PAM and unauthorized users.

In addition, according to one embodiment of the present invention, when root authority in a cloud management system is stolen, it is possible to block malicious execution on a container workload such as malicious behavior of distribution/execution/modification/deletion of containers or container images through access control of a security kernel user and container breakout that represents access to sensitive information on a host, for example, avoiding isolation monitoring of containers or obtaining additional authority.

That is, the present invention can enhance security of a Kubernetes dashboard having no access control function by blocking access of an unauthenticated host to the Kubernetes API server.

While the embodiments have been described with reference to limited examples and drawings as described above, it will be apparent to one of ordinary skill in the art that various changes and modifications may be made from the above description.

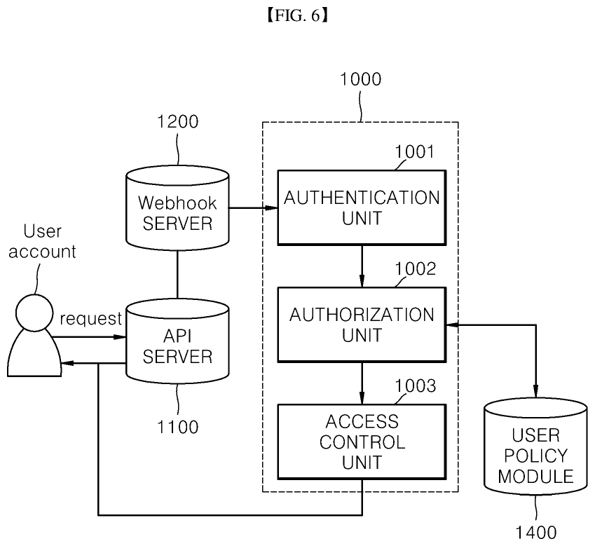

Next, FIG. 6 shows an example of a configuration diagram of an apparatus 1000 for controlling execution of an event stream-based container workload in a cloud environment according to one embodiment of the present invention.

As shown in FIG. 6, the present invention may include an authentication unit 1001, an authorization unit 1002, and an access control unit 1003 as main components of the apparatus 1000.

Specifically, the authentication unit 1001 functions to perform authentication on a user account by extracting identification information of the user account and confirming whether the extracted identification information is registered in a user policy module 1400 by hooking AdmissionView data, which is requested to a Kubernetes API server 1100 through an interface including at least one of a CLI and an API, using the webhook server 1200.

That is, the authentication unit 1001 may be understood as that all functions of S10 in FIG. 1 may be performed. According to the function of the authentication unit 1001 in the present invention, the authentication unit 1001 blocks access to the Kubernetes API server 1100 by an unauthenticated, that is, invalid user account, so that insufficient security can be enhanced.

In addition, when it is determined from the user policy module 1400 that the user account is an authenticated user account after performing the function of the authentication unit 1001, the authorization unit 1002 may determine execution authority of the AdmissionView data requested by the user account based on a security role and a security level set in the authenticated user account and verify AdmissionView data based on best practices.

That is, the authorization unit 1002 may be understood as performing all functions of S20 in FIG. 1, and even if one namespace is used by a plurality of user accounts in the present invention by performing the function of the authorization unit 1002, the authorization unit 1002 permits access only to the resources accessible to the user by confirming the user and a role of the user, so that insufficient security of the Kubernetes API server 110 can be enhanced.

Meanwhile, although not shown in FIG. 6, in correspondence with that the authorization step of FIG. 1 includes the first determination step, the second determination step, and the third determination step as described above, the authorization unit 1002 may include: a first determination unit that determines whether an IP address and a service port number of the user account are pre-registered host information by confirming whether the IP address and the service port number of the user account are registered in the user policy module; a second determination unit that determines whether the IP address of the user account is accessible to the Kubernetes API and a third determination unit that determines whether the user account has authority to execute verbs for resources specified in AdmissionView when the user account satisfies determination criteria set in the first determination unit and the second determination unit. However, the present invention is not limited thereto.

Next, the access control unit 1003 functions to perform access control for the AdmissionView data required to the Kubernetes API server 1100 by the user account according to a result of performing the function of the authorization unit 1002.

That is, the access control unit 1003 may be understood as performing all functions of S30 in FIG. 1. According to the function of the access control unit 1003 in the present invention, the access control unit 1003 may solve absence of authority setting according to a role of the user in association with the security kernel to block execution on container images that occurs at a security kernel level for PAM and an unauthorized user.

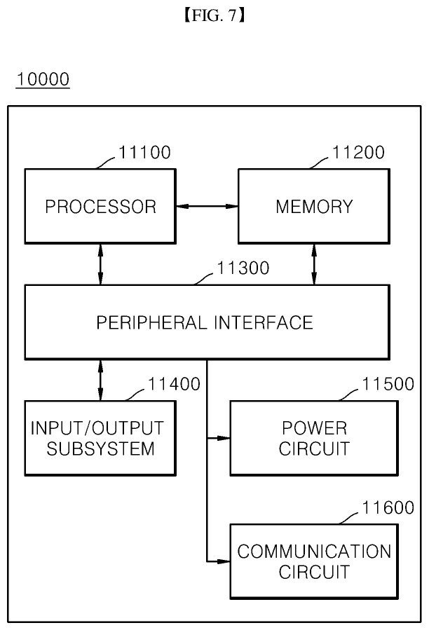

On the other hand, FIG. 7 shows an example of an internal configuration of a computing device according to one embodiment of the present invention. In the following description, unnecessary descriptions for embodiments redundant with those of FIGS. 1 to 6 will be omitted.

As shown in FIG. 7, a computing device 10000 may at least include at least one processor 11100, a memory 11200, a peripheral interface 11300, an input/output (I/O) subsystem 11400, a power circuit 11500, and a communication circuit 11600. In this case, the computing device 10000 may correspond to a user terminal A connected to a tactile interface device or correspond to the above-described computing device B.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 10000.

In this case, access to the memory 11200 from other components of the processor 11100 or the peripheral interface 11300, may be controlled by the processor 11100.

The peripheral interface 11300 may combine an input and/or output peripheral device of the computing device 10000 to the processor 11100 and the memory 11200. The processor 11100 may execute the software module or the instruction set stored in the memory 11200, thereby performing various functions for the computing device 10000 and processing data.

The input/output subsystem 11400 may combine various input/output peripheral devices to the peripheral interface 11300. For example, the input/output subsystem 11400 may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the input/output subsystem 11400.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or arbitrary other components for generating, managing, or distributing power.

The communication circuit 11600 may use at least one external port to enable communication with other computing devices.

Alternatively, as described above, the communication circuit 11600 may include an RF circuit, if needed, to transmit and receive an RF signal, also known as an electromagnetic signal, thereby enabling communication with other computing devices.

The above embodiment of FIG. 7 is merely an example of the computing device 10000, and the computing device 11000 may have a configuration or arrangement in which some components shown in FIG. 7 are omitted, additional components not shown in FIG. 7 are further provided, or at least two components are combined. For example, a computing device for a communication terminal in a mobile environment may further include a touch screen, a sensor or the like, in addition to the components shown in FIG. 7. The communication circuit 11600 may include a circuit for RF communication of various communication schemes (such as WiFi, 3G, LTE, Bluetooth, NFC, and Zigbee). The components that may be included in the computing device 10000 may be implemented by hardware, software, or a combination of both hardware and software which include at least one integrated circuit specialized in a signal processing or an application.

The methods according to the embodiments of the present invention may be implemented in the form of program instructions to be executed through various computing devices so as to be recorded in a computer-readable medium. In particular, a program according to the embodiment of the present invention may be configured as a PC-based program or an application dedicated to a mobile terminal. The application to which the present invention is applied may be installed in a user terminal through a file provided by a file distribution system. For example, a file distribution system may include a file transmission unit (not shown) that transmits the file according to the request of the user terminal.

The above-described device may be implemented by hardware components, software components, and/or a combination of hardware components and software components. For example, the devices and components described in the embodiments may be implemented by using at least one general purpose computer or special purpose computer such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system.

In addition, the processing device may access, store, manipulate, process, and create data in response to the execution of the software. For the further understanding, in some cases, one processing device may be used, however, those skilled in the art will be appreciated that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, an instruction, or a combination of at least one thereof, may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, and computer storage medium or device. The software may be distributed over computing devices connected to networks, so as to be stored or executed in a distributed manner. The software and data may be stored in at least one computer-readable recording medium.

The above-described embodiments of the present invention may be recorded in computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of computer-readable recording media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like.

Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

While the embodiments have been described with reference to limited examples and drawings as described above, it will be apparent to one of ordinary skill in the art that various changes and modifications may be made from the above description. Suitable results may be achieved if the described techniques are performed in a different order, and/or if components in a described system, architecture, device, or circuit are combined in a different manner, and/or replaced or supplemented by other components or their equivalents. Therefore, other implementations, other embodiments, and equivalents of the claims are within the scope of the following claims.

What is claimed is:

1. A method for controlling execution of an event stream-based container workload in a cloud environment, which is implemented by a computing device including one or more processors and one or more memories for storing instructions executable in the processors, the method comprising:
an authentication step of performing authentication on a user account by extracting identification information of the user account and confirming whether the extracted identification information is registered in a user policy module by hooking AdmissionView data, which is requested to a Kubernetes application programming interface (API) server through an interface including at least one of a command line interface (CLI) and an API, using a webhook server;
an authorization step of determining execution authority of the AdmissionView data requested by the user account based on a security role and a security level set in the authenticated user account, and verifying AdmissionView data based on best practices, when it is determined from the user policy module that the user account is an authenticated user account as a result of the authentication step; and
an access control step of controlling access to the AdmissionView data requested to the Kubernetes API server by the user account according to a result of the authorization step.

2. The method of claim 1, wherein the authentication step includes extracting information including at least one of header information about a request for the AdmissionView data, host information for requesting the AdmissionView data, and verbs request information about resources specified in the AdmissionView data as the identification information extracted from the AdmissionView data.

3. The method of claim 1, wherein the authorization step includes confirming whether the execution authority of the requested AdmissionView data is given to the user account by using role-based access control (RBAC), attribute-based access control (ABAC), and webhook.

4. The method of claim 3, wherein the authorization step includes:
a first determination step of determining whether an IP address and a service port number of the user account are pre-registered host information by confirming whether the IP address and the service port number of the user account are registered in the user policy module;
a second determination step of determining whether the IP address of the user account is an IP address accessible to the Kubernetes API server after the first determination step; and
a third determination step of determining whether the user account has authority to execute verbs for resources specified in AdmissionView when the user account satisfies preset determination criteria as results of the first determination step and the second determination step.

5. The method of claim 4, wherein the first determination step includes grasping the security role and the security level set in the user account by comparing the IP address and the service port number of the user account with access authority set for each namespace.

6. The method of claim 1, wherein the authentication step includes determining whether the user account is a valid user account by using a unit including at least one of a client certificate of the user account, a bearer token, an authentication proxy, and http basic authentication.

7. The method of claim 1, wherein the access control step includes:
permitting execution of the requested AdmissionView data by allowing the user account to access the Kubernetes API server when the execution authority of the AdmissionView data is given to the user account; and
denying the access of the user account to the Kubernetes API server when the execution authority of the AdmissionView data is not given to the user account.

8. An apparatus for controlling execution of an event stream-based container workload in a cloud environment, which is implemented by a computing device including one or more processors and one or more memories for storing instructions executable in the processors, the apparatus comprising:
an authentication unit that extracts identification information of a user account and confirms whether the extracted identification information is registered in a user policy module by hooking AdmissionView data, which is requested to a Kubernetes API server through an interface including at least one of a CLI and an API, using a webhook server;
an authorization unit that determines execution authority of the AdmissionView requested by the user account based on a security role and a security level set in the authenticated user account, and verifies AdmissionView data based on best practices, when it is determined from the user policy module that the user account is an authenticated user account as a result of a function of the authentication unit; and
an access control unit that controls access to the AdmissionView data requested to the Kubernetes API server by the user account according to a result of a function of the authorization unit.

9. A computer-readable recording medium that stores instructions for allowing a computing device to perform the following steps, wherein the steps comprise:
an authentication step of extracting identification information of a user account and confirming whether the extracted identification information is registered in a user policy module by hooking AdmissionView data, which is requested to a Kubernetes application programming interface (API) server through an interface including at least one of a command line interface (CLI) and an API, using a webhook server;
an authorization step of determining execution authority of the AdmissionView data requested by the user account based on a security role and a security level set in the authenticated user account, and verifying AdmissionView data based on best practices, when it is determined from the user policy module that the user account is an authenticated user account as a result of the authentication step; and
an access control step of controlling access to the AdmissionView data requested to the Kubernetes API server by the user account according to a result of the authorization step.
